(19) United States
(12) Patent Application Publication
(10) Pub. No.: US 2018/0037854 A1
(43) Pub. Date: Feb. 8, 2018

(54) Water-Soluble Unit Dose Article Comprising Hydrogenated Castor Oil

(71) Applicant: The Procter & Gamble Company, Cincinnati, OH (US)

(72) Inventors: Nigel Patrick Somerville Roberts, Newcastle upon Tyne (GB); Carlos Amador Zamarreno, Newcastle upon Tyne (GB); Antonio Quintieri, Brussels (BE); Alan Thomas Brooker, Newcastlel upon Tyne (GB); Harry William Broening, Milford, OH (US); Laura Bueno Romo, Newcastle upon Tyne (GB)

(21) Appl. No.: 15/663,850

(22) Filed: Jul. 31, 2017

(30) Foreign Application Priority Data
Aug. 4, 2016 (EP) 16182716.7

(51) Int. Cl. C11D 17/04; C11D 3/382; C11D 11/00

(52) U.S. Cl. CPC C11D 17/043; C11D 17/045; C11D 11/0017; C11D 3/382

(57) ABSTRACT

The present invention relates to water-soluble unit dose articles comprising hydrogenated castor oil, methods of their manufacture, and methods of their use.

### FIELD OF THE INVENTION

The present invention relates to water-soluble unit dose articles comprising hydrogenated castor oil, methods of their manufacture, and methods of their use.

### BACKGROUND OF THE INVENTION

Laundry wash operations involve the combination of fabrics to be washed with a detergent in a wash liquor. The wash liquor comprising the fabrics and detergent is then subjected to a wash operation. Oftentimes this is conducted in an automatic washing machine operation wherein the wash liquor is subjected to one or more cycles wherein each cycle involves the agitation of the wash liquor.

However, an issue with such wash operations is that often residues remain on the fabrics after the wash operation has finished, especially when using a water-soluble unit dose article. These residues are often undissolved detergent composition. This issue is especially seen under certain stressed wash conditions such as short and/or cold wash conditions. These short and/or cold wash conditions are becoming more popular as they are less environmentally impactful in that they are less resource and energy intensive. Other stressed wash conditions include low agitation washes, overfilled washing machines and low water wash cycles.

Therefore, there remains a need in the art for a water-soluble unit dose detergent composition that provides excellent fabric cleaning yet minimises detergent residues on fabrics, especially under more environmentally friendly or stressed conditions such as cold and/or quick wash conditions.

In addition, accidental rupture of the water-soluble unit dose article can result in inconvenient mess, e.g. contamination of neighbouring unit dose articles in storage container and/or on the hands of the consumer handling the unit dose article. Therefore there is a need for a water-soluble unit dose article that can be easily and conveniently used but wherein flow of liquid detergent out of prematurely ruptured pouches is minimized whilst still maintaining excellent cleaning.

The Inventors surprisingly found that the composition of the present invention overcame these technical problems.

### SUMMARY OF THE INVENTION

A first aspect of the present invention is a water-soluble unit dose article comprising a water-soluble film and a liquid laundry detergent composition, wherein the liquid laundry detergent composition comprises a non-soap anionic surfactant and between 0.15% to 1% by weight of the liquid laundry detergent composition of hydrogenated castor oil.

A second aspect of the present invention is a method of washing comprising the steps of;
a. obtaining a water-soluble unit dose article according to the present invention;
b. contacting the water-soluble unit dose article with sufficient water to dilute the liquid detergent composition by a factor of at least 300 fold to make a wash liquor;
c. washing items to be cleaned in said wash liquor.

A third aspect of the present invention is the use of a liquid laundry detergent composition comprising a non-soap anionic surfactant and between 0.1 to 1% by weight of the liquid laundry detergent composition of hydrogenated castor oil comprised in a water-soluble unit dose article according to the present invention to reduce instances of detergent residue on fabrics.

### DETAILED DESCRIPTION OF THE INVENTION

### Water-Soluble Unit Dose Article

The present invention relates to a water-soluble unit dose article comprising a water-soluble film and a liquid laundry detergent composition.

The water-soluble film is described in more detail below. The liquid detergent composition is described in more detail below.

The water-soluble unit dose article comprises the water-soluble film shaped such that the unit-dose article comprises at least one internal compartment surrounded by the water-soluble film. The unit dose article may comprise a first water-soluble film and a second water-soluble film sealed to one another such to define the internal compartment. The water-soluble unit dose article is constructed such that the detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. During manufacture, a first water-soluble film may be shaped to comprise an open compartment into which the detergent composition is added. A second water-soluble film is then laid over the first film in such an orientation as to close the opening of the compartment. The first and second films are then sealed together along a seal region.

The unit dose article may comprise more than one compartment, even at least two compartments, or even at least three compartments. The compartments may be arranged in superposed orientation, i.e. one positioned on top of the other. In such an orientation the unit dose article will comprise three films, top, middle and bottom. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the detergent composition according to the present invention may be comprised in at least one of the compartments. It may for example be comprised in just one compartment, or may be comprised in two compartments, or even in three compartments.

Each compartment may comprise the same or different compositions. The different compositions could all be in the same form, or they may be in different forms.

The water-soluble unit dose article may comprise at least two internal compartments, wherein the liquid laundry detergent composition is comprised in at least one of the compartments, preferably wherein the unit dose article comprises at least three compartments, wherein the detergent composition is comprised in at least one of the compartments. If more than one compartment comprises a liquid formulation, at least one, preferably at least two, most preferably all of the liquid detergent formulations are liquid detergent compositions according to the invention. If more than one compartment comprises a liquid formulation, and solely one or more but not all of the liquid detergent formulations are liquid detergent compositions according to the invention, preferably the largest compartment(s) comprising a liquid detergent composition comprise a liquid detergent formulation according to the invention.

The water-soluble unit dose article may comprise between 10 ml and 35 ml, preferably between 15 ml and 32 ml, more preferably between 18 ml and 30 ml, most preferably between 18 ml and 26 ml of the liquid laundry detergent composition.

The water-soluble unit dose article has a height, a width and a length, and wherein preferably;
the maximum length is between 2 and 10 cm, preferably 2 and 5 cm;
the maximum width is between 2 and 5 cm; and
the maximum height is between 1 and 5 cm, preferably between 2 and 5 cm.

The maximum length may be between 2 cm and 4 cm, or even between 2 cm and 3 cm. The maximum length maybe greater than 2 cm and less than 6 cm

The maximum width is between 2 cm and 5 cm. The maximum width maybe greater than 3 cm and less than 6 cm.

The maximum height maybe greater than 2 cm and less than 4 cm.

Preferably, the length:height ratio is from 6:1 to 1:1 more preferably 3:1 to 1:1; or the width:height ratio is from 3:1 to 1:1, or even 2.5:1 to 1:1; or the ratio of length to height is from 6:1 to 1:1 or even 3:1 to 1:1 and the ratio of width to height is from 3:1 to 1:1, or even 2.5:1 to 1:1, or a combination thereof.

### Water-Soluble Film

The film of the present invention is soluble or dispersible in water. The water-soluble film preferably comprises polyvinyl alcohol or a copolymer thereof. Preferably, the water-soluble film comprises a blend of at least two different polyvinylalcohol homopolymers, at least two different polyvinylalcohol copolymers, at least one polyvinylalcohol homopolymer and at least one polyvinylalcohol copolymer or a combination thereof.

Preferably, the water-soluble film has a thickness between 50 microns and 100 microns, preferably between 70 microns and 90 microns before being deformed into a unit dose article.

Preferably, the film has a water-solubility of at least 50%, preferably at least 75% or even at least 95%, as measured by the method set out here after using a glass-filter with a maximum pore size of 20 microns:

5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Preferably, the water-soluble unit dose article comprises polyvinylalcohol.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol.

Preferred for use herein are PVA polymers which are from about 60% to about 98% hydrolysed, preferably about 80% to about 90% hydrolysed, to improve the dissolution characteristics of the material.
Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol.

Of the total PVA resin content in the film described herein, the PVA resin can comprise about 30 to about 85 wt % of the first PVA polymer, or about 45 to about 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP, measured as a 4% polymer solution in demineralized water at 20° C.

Preferably the film comprises a blend of at least two different polyvinylalcohol homopolymers and/or copolymers.

Most preferably the water soluble film comprises a blend of at least two different polyvinylalcohol homopolymers, especially a water soluble film comprising a blend of at least two different polyvinylalcohol homopolymers of different average molecular weight, especially a blend of 2 different polyvinylalcohol homopolymers having an absolute average viscosity difference |μ₂−μ₁| for the first PVOH homopolymer and the second PVOH homopolymer, measured as a 4% polymer solution in demineralized water, in a range of 5 cP to about 15 cP, and both homopolymers having an average degree of hydrolysis between 85% and 95% preferably between 85% and 90%. The first homopolymer preferably has an average viscosity of 10 to 20 cP preferably 10 to 15 cP The second homopolymer preferably has an average viscosity of 20 to 30 cP preferably 20 to 25 cP. Most preferably the two homopolymers are blended in a 40/60 to a 60/40 weight % ratio.

Alternatively the water soluble film comprises a polymer blend comprising at least one copolymer comprising polyvinylalcohol and anionically modified monomer units. In particular the polymer blend might comprise a 90/10 to 50/50 weight % ratio of a polyvinylalcohol homopolymer and a copolymer comprising polyvinylalcohol and anionically modified monomer units. Alternatively the polymer blend might comprise a 90/10 to 10/90 weight % ratio of two different copolymers comprising polyvinylalcohol and anionically modified monomer units.

General classes of anionic monomer units which can be used for the PVOH corpolymer include the vinyl polymerization units corresponding to monocarboxylic acid vinyl monomers, their esters and anhydrides, dicarboxylic monomers having a polymerizable double bond, their esters and anhydrides, vinyl sulfonic acid monomers, and alkali metal salts of any of the foregoing. Examples of suitable anionic monomer units include the vinyl polymerization units corresponding to vinyl anionic monomers including vinyl acetic acid, maleic acid, monoalkyl maleate, dialkyl maleate, monomethyl maleate, dimethyl maleate, maleic anyhydride, fumaric acid, monoalkyl fumarate, dialkyl fumarate, monomethyl fumarate, dimethyl fumarate, fumaric anyhydride, itaconic acid, monomethyl itaconate, dimethyl itaconate, itaconic anhydride, vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, 2-sufoethyl acrylate, alkali metal salts of the foregoing (e.g., sodium, potassium, or other alkali metal salts), esters of the foregoing (e.g., methyl, ethyl, or other C₁-C₄ or C₆ alkyl esters), and combinations thereof (e.g., multiple types of anionic monomers or equivalent forms of the same anionic monomer). In an aspect, the anionic monomer can be one or more acrylamido methylpropanesulfonic acids (e.g., 2-acrylamido-1-methylpropanesulfonic acid, 2-acrylamido-2-methylpropanesulfonic acid, 2-methylacrylamido-2-methylpropanesulfonic acid), alkali metal salts thereof (e.g., sodium salts), and combinations thereof. In an aspect, the anionic monomer can be one or more of monomethyl maleate, alkali metal salts thereof (e.g., sodium salts), and combinations thereof.

The level of incorporation of the one or more anionic monomer units in the PVOH copolymers is not particularly limited. In some aspects, the one or more anionic monomer units are present in a PVOH copolymer in an amount in a range of about 2 mol. % to about 10 mol. % (e.g., at least 2.0, 2.5, 3.0, 3.5, or 4.0 mol. % and/or up to about 3.0, 4.0, 4.5, 5.0, 6.0, 8.0, or 10 mol. % in various embodiments), individually or collectively.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, dipropylene glycol, sorbitol and mixtures thereof. Other additives may include water and functional detergent additives, including surfactant, to be delivered to the wash water, for example organic polymeric dispersants, etc.

The film may be opaque, transparent or translucent. The film may comprise a printed area. The printed area may cover between 10% and 80% of the surface of the film; or between 10% and 80% of the surface of the film that is in contact with the internal space of the compartment; or between 10% and 80% of the surface of the film and between 10% and 80% of the surface of the compartment.

The area of print may cover an uninterrupted portion of the film or it may cover parts thereof, i.e. comprise smaller areas of print, the sum of which represents between 10% and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000 s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 ppm.

### Liquid Detergent Composition

The composition of the present invention is a liquid laundry detergent composition. The term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as tablets or granules.

The liquid laundry detergent composition comprises a non-soap anionic surfactant and between 0.15% to 1% by weight of the liquid laundry detergent composition of hydrogenated castor oil.

The liquid laundry detergent composition may comprise between 5% and 45%, preferably between 10% and 40%, more preferably between 15% and 35%, most preferably between 20% and 30% by weight of the liquid detergent composition of the non-soap anionic surfactant.

Alternatively, the liquid laundry detergent composition may comprise between 5% and 35%, preferably between 5% and 20%, more preferably between 5% and 15% by weight of the liquid laundry detergent composition of the non-soap anionic surfactant.

The non-soap anionic surfactant may be selected from linear alkylbenzene sulphonate, alkyl sulphate, alkoxylated alkyl sulphate or a mixture thereof. Preferably, the non-soap anionic surfactant comprises linear alkylbenzene sulphonate and alkoxylated alkyl sulphate and preferably the weight ratio of linear alkylbenzene sulphonate to alkoxylated alkyl sulphate is from 2:1 to 1:8 preferably from 1:1 to 1:5 most preferably from 1:1.25 to 1:4.

The liquid laundry detergent composition may comprise a non-ionic surfactant, preferably wherein the non-ionic surfactant is selected from a fatty alcohol alkoxylate, an oxo-synthesised fatty alcohol alkoxylate, Guerbet alcohol alkoxylates, alkyl phenol alcohol alkoxylates or a mixture thereof. The liquid laundry detergent composition may comprise between 1% and 25%, preferably between 1.5% and 20%, most preferably between 2% and 15% by weight of the liquid laundry detergent composition of the non-ionic surfactant.

The weight ratio of non-soap anionic surfactant to non-ionic surfactant may be from 1:1 to 20:1, preferably from 1.3:1 to 15:1, more preferably from 1.5:1 to 10:1.

The liquid laundry detergent composition may comprise between 0.15% and 0.75%, preferably between 0.15% and 0.5%, more preferably between 0.175% and 0.3% by weight of the liquid laundry detergent composition of hydrogenated castor oil.

Hydrogenated castor oil (HCO) as used herein most generally can be any hydrogenated castor oil or derivative thereof, provided that it is capable of crystallizing in the liquid laundry detergent composition. Castor oils may include glycerides, especially triglycerides, comprising C₁₀ to C₂₂ alkyl or alkenyl moieties which incorporate a hydroxyl group. Hydrogenation of castor oil, to make HCO, converts the double bonds which may be present in the starting oil as ricinoleyl moieties. As such, the ricinoleyl moieties are converted into saturated hydroxyalkyl moieties, e.g., hydroxystearyl. The HCO herein may be selected from: trihydroxystearin; dihydroxystearin; and mixtures thereof. The HCO may be processed in any suitable starting form, including, but not limited to those selected from solid, molten and mixtures thereof.

HCO of use in the present invention includes those that are commercially available. Non-limiting examples include those supplied by Elementis, Plc.

The liquid detergent composition may comprise between 1% and 25%, preferably between 1.5% and 20%, more preferably between 1% and 25%, preferably between 1.5% and 20%, most preferably between 2% and 15% by weight of the liquid detergent composition of soap.

The liquid laundry detergent composition may comprise a cleaning or care polymer, preferably wherein the cleaning or care polymer is selected from an ethoxylated polyethyleneimine, alkoxylated polyalkyl phenol, an amphiphilic graft copolymer, a polyester terephthalate, a hydroxyethylcellulose, a carboxymethylcellulose or a mixture thereof.

The water-soluble unit dose article may comprise a brightener, a hueing dye or a mixture thereof.

The water-soluble unit dose article may comprise from 0.1% to 25%, preferably from 1% to 20%, more preferably from 3% to 17%, even more preferably from 5% to 15%, most preferably from 8% to 13% by weight of the water-soluble unit dose article of water.

The water-soluble unit dose article may comprise between 10% and 50%, preferably between 15% and 40%, more preferably between 20% and 35% of a non-aqueous organic solvent. The organic solvent is preferably selected from the group comprising glycerol, 1,2-propanediol, dipropylene glycol, alkanolamine or a mixture thereof. Preferably, the alkanolamine is selected from monoethanolamine, triethanolamine or mixtures thereof.

The liquid laundry detergent composition may have a viscosity preferably a non-Newtonian viscosity, of between 4.5 Pa·s and 35 Pa·s, preferably between 6 Pa·s. and 25 Ps·a, more preferably between 10 Pa·s and 20 Pa·s, most preferably between 12 Pa·s and 16 Pa·s at a shear rate of 0.5 s⁻¹ as measured using a TA Rheometer AR2000 at 25° C. Preferably the liquid laundry detergent composition has a viscosity of between 0.5 Pa·s and 2 Pa·s at a shear rate of 1005⁻¹ as measured using a TA Rheometer AR2000 at 25° C. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate.

### Method of Making

Those skilled in the art will know how to manufacture the water-soluble unit dose article and the liquid detergent composition using common techniques known in the art.

One aspect of the present invention is the water-soluble unit dose article according to the present invention wherein manufacture of the liquid detergent composition comprises the steps of;
a. preparing a first liquid premix comprising the non-soap anionic surfactant;
b. preparing a second liquid premix comprising the hydrogenated castor oil and water, preferably wherein the second liquid premix comprises between 10% and 95% preferably between 20% and 90%, more preferably between 30% and 85%, most preferably between 40% and 80% by weight of the second liquid premix of water;
c. mixing the second premix into the first premix.

Without wishing to be bound by theory, mixing in the hydrogenated castor oil premix at a late stage in the process is believed to reduce the risk of partially destroying the internal structure built by the hydrogenated castor oil under influence of prolonged mixing conditions.

### Method of Washing

A further aspect of the present invention is a method of washing comprising the steps of;
a. obtaining a water-soluble unit dose article according to the present invention;
b. contacting the water-soluble unit dose article with sufficient water to dilute the liquid detergent composition by a factor of at least 300 fold to make a wash liquor;
c. washing items to be cleaned in said wash liquor.

### Use

A further aspect of the present invention is the use of a liquid laundry detergent composition comprising a non-soap anionic surfactant and between 0.1 to 1% by weight of the liquid laundry detergent composition of hydrogenated castor oil comprised in a water-soluble unit dose article to reduce instances of detergent residue on fabrics.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### EXAMPLES

### Example 1

Three water-soluble unit dose articles were prepared comprising standard liquid laundry detergent compositions, as used in off-the-shelf products at the time of filing this invention. The unit dose article was a three-compartment superposed design. The liquid laundry detergent compositions comprised different levels of hydrogenated castor oil, and each comprising non-soap anionic surfactant.

The viscosity of the three liquid detergent compositions was measured at a shear rate of 0.5 s⁻¹ as measured using a TA Rheometer AR2000 at 25° C.

As can be seen in table 1, the water-soluble unit dose article comprising detergent compositions within the scope of the present invention claims had acceptable rheologies of 10 and 13 Pa·s.

TABLE 1

| HCO | |
|---|---|
| [wt %] | viscosity [Pa · s] |
| 0.12 | 5 |
| 0.24 | 10 |
| 0.52 | 13 |

### Example 2

The flow of liquid detergent composition out of unit dose articles comprising holes was assessed.

Two unit dose articles were prepared comprising water-soluble films and liquid detergent compositions.

The viscosity of the liquid detergent composition in all three was measured at a shear rate of 0.5 s⁻¹ as measured using a TA Rheometer AR2000 at 25° C.

Each of these was compressed between two plates at a pressure of 100N for 3 seconds using an Instron Universal Materials Testing instrument with a load cell of maximum 100 kN, and 0% of the liquid detergent composition was observed to escape from the unit dose article;

Next to each of these a hole is introduced into the water-soluble film in contact with the largest compartment on the side of the water-soluble unit dose article not in contact with the plates using a needle having a 1 mm diameter. The unit dose article was then compressed between the two plates at a pressure of 100N for 3 seconds using an Instron Universal Materials Testing instrument with a load cell of maximum 100 kN.

The following results were observed.

TABLE 3

| Unit | Viscosity of liquid | | HCO |
|---|---|---|---|
| dose | detergent composition | Spillage | level |
| article | measured at 20 C., 0.5 s⁻¹ | amount (g) | (wt %) |
| 1 | 3 [Pa · s] | 10-15 | 0.12% |
| 2 | 13 [Pa · s] | 5-8 | 0.52% |

Unit dose article 2 provided for a reasonable volume of liquid escape upon accidental rupture and simulated compression (e.g. other unit dose articles being on top of the ruptured unit dose article).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition of the same term in a document incorporated by reference, the meaning of definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A water-soluble unit dose article comprising a water-soluble film and a liquid laundry detergent composition, wherein the liquid laundry detergent composition comprises a non-soap anionic surfactant and between about 0.15% to about 1% by weight of the liquid laundry detergent composition of hydrogenated castor oil.

2. The water-soluble unit dose article according to claim 1 wherein the liquid laundry detergent composition comprises between about 0.15% and about 0.75%, by weight of the liquid laundry detergent composition of hydrogenated castor oil.

3. The water-soluble unit dose article according to claim 1 comprising between about 5% and about 45%, by weight of the liquid detergent composition of the non-soap anionic surfactant.

4. The water-soluble unit dose article according to claim 3 wherein the non-soap anionic surfactant is selected from linear alkylbenzene sulphonate, alkyl sulphate, alkoxylated alkyl sulphate or a mixture thereof.

5. The water-soluble unit dose article according to claim 4 wherein the non-soap anionic surfactant comprises linear alkylbenzene sulphonate and alkoxylated alkyl sulphate and the weight ratio of linear alkylbenzene sulphonate to alkoxylated alkyl sulphate is from about 2:1 to about 1:8.

6. The water-soluble unit dose article according to claim 1 wherein the liquid laundry detergent composition comprises a non-ionic surfactant, wherein the non-ionic surfactant is selected from a fatty alcohol alkoxylate, an oxo-synthesised fatty alcohol alkoxylate, Guerbet alcohol alkoxylates, alkyl phenol alcohol alkoxylates or a mixture thereof.

7. The water-soluble unit dose article according to claim 6 wherein the liquid laundry detergent composition comprises between about 1% and about 25%, by weight of the liquid laundry detergent composition of the non-ionic surfactant.

8. The water-soluble unit dose article according to claim 6 wherein the weight ratio of non-soap anionic surfactant to non-ionic surfactant is from about 1:1 to about 20:1.

9. The water-soluble unit dose article according to claim 1 wherein the liquid detergent composition comprises between about 1% and about 25%, by weight of the liquid detergent composition of soap.

10. The water-soluble unit dose article according to claim 1 wherein the liquid laundry detergent composition comprises a cleaning or care polymer, wherein the cleaning or care polymer is selected from an ethoxylated polyethyleneimine, alkoxylated polyalkyl phenol, an amphiphilic graft copolymer, a polyester terephthalate, a hydroxyethylcellulose, a carboxymethylcellulose or a mixture thereof.

11. The water-soluble unit dose article according to claim 1 comprising a brightener, a hueing dye or a mixture thereof.

12. The water-soluble unit dose article according to claim 1 wherein the water-soluble film is a polymeric water-soluble film,

13. The water-soluble unit dose article according to claim 12 wherein the water-soluble film comprises polyvinyl alcohol.

14. The water-soluble unit dose article according to claim 1 wherein the water-soluble unit dose article comprises from about 0.1% to about 25% by weight of the water-soluble unit dose article of water.

15. The water-soluble unit dose article according to claim 1 comprising between about 10% and about 50% of a non-aqueous organic solvent, wherein said organic solvent is selected from the group comprising glycerol, 1,2-propanediol, dipropylene glycol, alkanolamine or a mixture thereof.

16. The water-soluble unit dose article according to claim 15 wherein the alkanolamine is selected from monoethanolamine, triethanolamine or mixtures thereof.

17. The water-soluble unit dose article according to claim 1 wherein manufacture of the liquid detergent composition comprises the steps of;
a. preparing a first liquid premix comprising the non-soap anionic surfactant;
b. preparing a second liquid premix comprising the hydrogenated castor oil and water, wherein the second liquid premix comprises between about 10% and about 95% by weight of the second liquid premix of water;
c. mixing the second premix into the first premix.

18. The water-soluble unit dose article according to claim 1 wherein the water-soluble unit dose article comprises at least one compartment.

19. The water-soluble unit dose article according to claim 18 comprising at least two compartments and wherein the compartments are arranged in a side-by-side orientation relative to one another or are arranged in a superposed orientation relative to one another.

20. (canceled)
